(19) United States
(12) Patent Application Publication
(10) Pub. No.: US 2010/0306196 A1
(43) Pub. Date: Dec. 2, 2010

(54) METHOD AND DEVICE FOR THE INDIVIDUAL STORAGE OF PUBLIC INFORMATION

(76) Inventor: Franziska Lindemeier, Erkrath (DE)

Correspondence Address: Hoffberg & Associates, 10 Bank Street, Suite 460, White Plains, NY, 10606, US

(21) Appl. No.: 12/599,216

(22) PCT Filed: May 6, 2008
(86) PCT No.: PCT/EP2008/055536

§ 371 Date: Nov. 6, 2009

(30) Foreign Application Priority Data
May 7, 2007 (DE) 10 2007 021 780.5

(51) Int. Cl. G06F 17/30; G06F 15/16

(52) U.S. Cl. 707/736; 709/217; 707/E17.044

(57) ABSTRACT

The invention relates to a method for the individual storage of public information, characterized by the following steps: providing information in a digital information storage unit of an information provider; marking the information thus provided with an individual, explicit marker; publishing the information with the associated marker; receiving information requests sent by users in the form of selected markers; and providing the public information associated with the selected markers to the user for further use.

### TECHNICAL FIELD

The invention relates to a method and a device for the individual storage of public information.

The ever growing amount of information in various media makes it difficult for people to store and structure information. Typical media are newspapers, magazines, books, advertising media and brochures (print media), radio- and television broadcasts, videos and the internet.

It is, however, difficult to individually and electronically store and use information provided for a user on demand. For example, articles in magazines or newspapers and brochures are cut out and stored. Advertisements are limited to statements which are easy to remember hoping that the target group will remember the message without further support until its further use, i.e. when going shopping, for example.

### PRIOR ART

It is possible in principle to order a video sequence from a television broadcaster, a music title from a radio broadcaster or a newspaper article from the publisher in retrospect. However, this requires some efforts. The publisher or broadcaster must be addressed for each individual offer of information. This is tiring. The offer of information must be accurately identified. This involves the risk of a mix-up. Furthermore, information publishers are not well equipped for providing individual information on a one-by-one basis. Therefore, such requests for information remain an exception.

It is known to provide information with a weblink. The user can write down the weblink and search the site of the information provider in the internet for the desired information. However, a time consuming search procedure is necessary for this purpose. Weblinks to individual pages are complex and almost not suited to be remembered. Much information is not provided in the internet at all.

It is also known to provide television programs with a code. Such codes, known as VPS-Codes, enable the viewer to record television programs with a video recorder. The recording can be carried out without difficult programming of the video recorder entering the television channel and the broadcasting time. It is only necessary to enter the VPS-Code. There is no request to the information provider. Ordering the video sequence after the broadcasting time is not possible.

### DISCLOSURE OF THE INVENTION

It is an object of the invention to provide a method and a device for collecting and providing various information of different providers in different media according to the specification of the user. According to the invention this object is achieved by a method with the steps:
(a) Providing information of an information provider in a digital information storage;
(b) Marking the provided information with an individual, unambiguous code;
(c) Publishing the information together with the corresponding code;
(d) Receiving information requests sent by the user in the form of selected codes; and
(e) Providing the published information corresponding to the selected codes to the user for further use.

The information is stored anyway in digital form at the information provider, i.e. with the publishers or broadcasters. Each information or information package is now provided with a code according to the present invention. Such a code may be a letter-number-code, a bar code or the like. The code is published together with the information in the normal way. The code may then be added below a newspaper article, the code unambiguously identifying the newspaper article.

It is understood that the term “code” comprises all kinds of unambiguous identification codes. It is, for example, also possible to use general coding rules in order to provide certain broadcasting timeslots or publishing locations with a date and thereby allow an unambiguous identification. In this case the indication at the end of the information package may be completely avoided.

The user has then the option to request information. For this purpose he may send the code by, for example, a cellular phone or the internet to a receiving device which is suitably equipped.

A sender code is sent in addition to the code. Such a sender code can be the telephone number of the sending cellular telephone. The data received with the receiving device is processed in a central computer and allocated to the user by means of the sender code. The information provider is retrieved with the code. The information provider can be directly represented in the form of an abbreviation if the code is a letter-number-code. If the code is a bar code which is, for example, recorded with the camera of a telephone and transmitted in the form of a multi media message (MMS) the bar code is processed at first and then the information is identified.

The central computer requests the information corresponding to the code from the information providers and individually provides them to the user. Such a request is preferably effected in such a way, that the information provider automatically reads a data base. The information is provided in such a data base together with the code.

Published information can be sent to a digital mail box of the user. Such a transmission can be effected by, for example, email.

Published information can also be stored in a storage attributed to the user which is accessible for the user through a network, such as the internet. The user obtains storage capacity on a server, for example upon payment of a fee, the server being accessible from a client through the internet or another suitable network. The information is provided in this storage according to the requests.

Preferably the information request is sent through a cellular telephone by the user and received by the receiving devices of a mobile network. Due to the wide use of cellular telephones and the unambiguous attribution of the user this way of transmission is particularly suitable. It is not necessary anymore to separately identify the user.

However, there is still the possibility that the user chooses to remain anonymous. The information provider receives an information request. During administration the information provider only communicates with the central computer and will not receive sensible, personal data of the user, such as name, address etc.

The information provider has the option to provide the information with additional information or advertisements. This information mixture is then transmitted together. Due to the unambiguous coding of the publication and the amount of corresponding requests the information provider will receive important information about the ways of distribution and the acceptance of his programs.

The method is particularly advantageous, if the publication of the information is effected in print media, radio, television and/or internet. With such kinds of publications information is collected in a central computer and is available in digital form for the applicant. A uniform way of storing enables the common administration and evaluation.

The central computer is part of a device for carrying out the method, additionally comprising:
(a) a receiving device for receiving information requests of a user in the form of a selected code corresponding to information;
(b) a user specific individual, digital storage for storing user specific data;
(c) user operated means for starting the transmission of the information corresponding to the code and provided by a provider to a target address defined by the user.

The target address may be the individual, digital storage where the information corresponding to the code can be stored. The information can be directly sent to the user or it can be accessed by the user, for example, via the internet. Alternatively, the target address is an electronic mail box.

Further modifications of the invention are subject matter of the subclaims. An embodiment is described below in greater detail with reference to the accompanying drawings.

### BRIEF DESCRIPTION OF THE DRAWINGS

FIG. 1 illustrates the individual storage of public information where the information is stored in a specific storage.

FIG. 2 is a representation as in FIG. 1, the information, however, is sent via email.

### DESCRIPTION OF THE EMBODIMENT

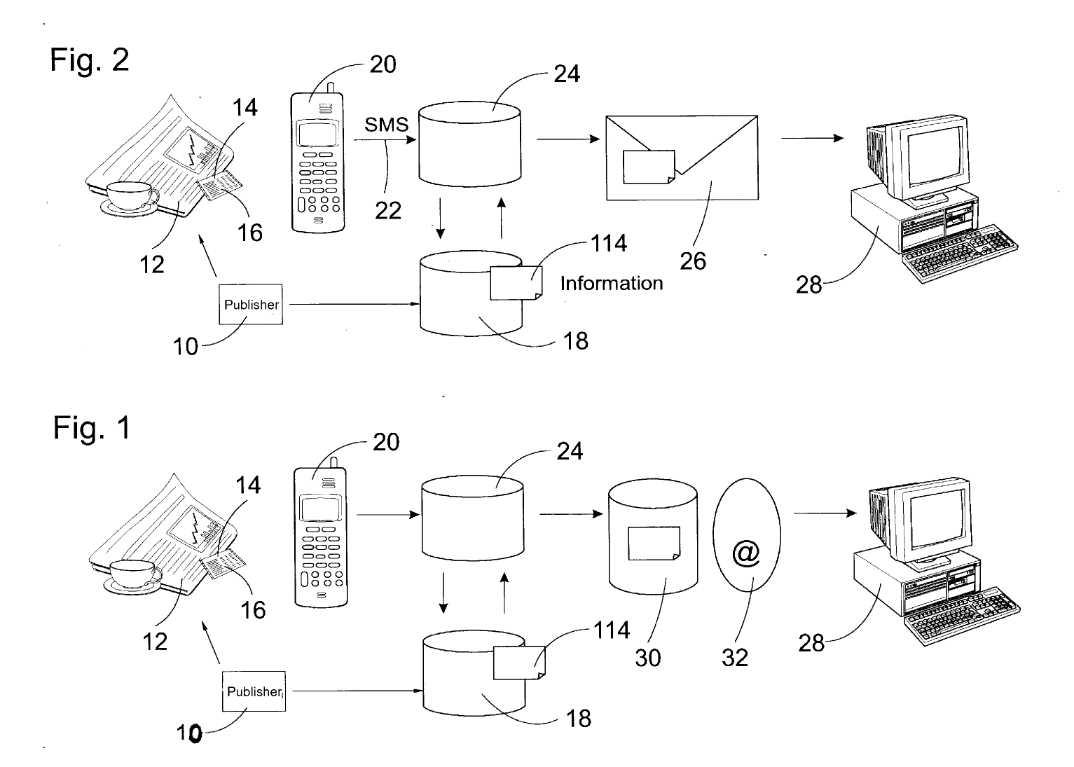

FIG. 1 illustrates how information daily present for a user can be recorded and digitally stored. In the present embodiment the information provider is a publisher 10. The publisher publishes a newspaper 12 with numerous articles 14 and advertisements. Each of the articles 14 is provided with a code 16. The code is unambiguous and the newspaper article can be unambiguously identified by the code. An example for such a code 16 is:

de.spiegel.120307.a.adx

The code is composed of the abbreviation for the country (de), the information provider (spiegel), the date in six-digit format (120307), the information channel (a) and a article code (adx). In the present embodiment such abbreviations are separated by dots.

Further publications can be denoted in the same way even if the publication is effected by television or in the form of an advertisement brochure or the like. A television program, for example, can be denoted by:

de.ard.120307.s.aat

This would mean that the program broadcasted on the 12 Mar. 2007 with the abbreviation code aat on the german channel s of the ARD is defined.

Simultaneously with the publication, a copy 114 of the coded article of the publisher or a video sequence with the coded television program etc. is stored in a provider storage 18. The code serves as an index.

A user whose attention is drawn to an article 14 in the newspaper 12 has now the option to have this article individually provided. With his cellular telephone 20 he will send a short message (SMS) with the code through the mobile network 22 to a receiver (not shown). The receiver forwards the message to a central computer 24.

User data are stored in the central computer 24. Such user data comprise the telephone number of the cellular telephone of the user and information about the way how information shall be provided. Furthermore, personal data, such as name, address, email addresses, accounting information etc. can be stored in the central computer.

The central computer 24 determines the information provider from the code. In the present example the information provider is the publisher 10. The central computer 24 will then access the files with the desired information stored in the data base 18 through a secured transmission path and will download such files to an intermediate storage. The information request may be subject to certain conditions, such as payment, registration of the user or the like. If such conditions are fulfilled the file with the desired information is provided to the user.

The information can be provided in various ways. Users with internet access may receive the file electronically through electronic mail (email) 26 to an electronic mail box which has been previously notified. The information is accessed through a computer 28. This is shown in FIG. 2.

Alternatively, the user has his own storage capacity in a storage 30 which is accessible through the internet 32. The user has then the option of collecting and administrating the information there, to add further information and data and to process the entire lot.

The method has the advantage that the user may be anonymous if desired. His data are administered in the central computer 24. Nevertheless, the information provider obtains information about the amount and kind of requested information and thereby an important feedback about the quality of his publications and the interest caused thereby. The information provider can also transmit further information together with the requested information. In such a way an information request relating to an advertisement or a product may cause further information about the requested product, about sales channels or further services in this area and the like.

It is understood, that the transmission paths may vary. It is also possible to use email, MMS (multi media message), an image of the product, article or barcode, a telephone call with voice recognition or the like instead of SMS. Also, the transmission of the information may be effected by all kinds of known transmission paths.

While the invention has been described in this embodiment in great detail by way of example it becomes apparent to the person skilled in the art that various modifications are possible without departing from the general idea of the invention which is defined by the appended claims. Such details and embodiments are, therefore, meant only to illustrate the invention and not to limit the scope of the invention as claimed in the claims.

What is claimed is:

1. A method for individual storing of public information with the steps of:
(a) providing information of an information provider in a digital information storage;
(b) marking said information with an individual, unambiguous code;
(c) publishing said information together with said code;
(d) receiving information requests sent by a user in the form of selected ones of said codes; and
(e) providing said information corresponding to said selected ones of said codes to said user for further use.

2. The method according to claim 1, wherein said information is sent to a digital mail box of said user.

3. The method according to claim 1, wherein said information is stored in a storage attributed to said user which is accessible for said user through a network such as the internet.

4. The method according to claim 1, wherein said information requests are sent through a cellular telephone by said user and received by receiving devices of a mobile network.

5. The method according to claim 1, wherein said information is published in print media, radio, television and/or in the internet.

6. A device for carrying out a method for individual storing of public information, said information being provided with an individual, unambiguous code, comprising:
(a) a receiving device for receiving information requests of a user in the form of a selection of said codes;
(b) a user specific individual, digital storage for storing user specific data;
(c) user operated means for starting a transmission of said information corresponding to said code to a target address defined by the user.

7. The device according to claim 6, wherein said target address is an address of said individual, digital storage.

8. The device according to claim 6, wherein said target address is an electronic mail box.

9. The device according to claim 6, wherein said receiving device is adapted to receive signals of a mobile network.

10. The device according to claim 6, having an access to said individual, digital storage through the internet or another global network.

11. A device for storing of identifying information, comprising:
(a) a receiver adapted to receive a request from a user based on a selection of an information-identifying code selected from a plurality of available codes;
(b) a digital storage medium adapted to store user-specific data associated with respective information-identifying codes;
(c) a user-operated transmitter adapted to start a transmission of said user-specific data corresponding to said selected code, to a target address defined by the user.

12. The device according to claim 11, wherein said target address is an address of said individual, digital storage.

13. The device according to claim 11, wherein said target address is an electronic mail box.

14. The device according to claim 11, wherein said receiving device is adapted to receive signals from a mobile communication network.

15. The device according to claim 11, wherein said digital storage medium is accessible through the Internet.
